(19) United States
(12) Patent Application Publication
(10) Pub. No.: US 2012/0208549 A1
(43) Pub. Date: Aug. 16, 2012

(54) AUTOMATIC CHECK-OUT UPON LOCATION DEPARTURE

(75) Inventors: James Lau, Bellevue, WA (US); Udiyan Padmanabhan, Seattle, WA (US); Vinay Gupta, Sammamish, WA (US)

(73) Assignee: MICROSOFT CORPORATION, Redmond, WA (US)

(21) Appl. No.: 13/027,757

(22) Filed: Feb. 15, 2011

(51) Int. Cl. G06F 15/16; H04W 24/00; H04W 4/02

(52) U.S. Cl. 455/456.1; 455/422.1; 709/205

(57) ABSTRACT

Systems and methods are disclosed for detecting termination of a social check-in session where a user has checked into a location using a mobile device. Upon detecting that the user has left a location, the present system automatically checks the user out of that location, and updates the user's records and friends that the user is no longer at that location.

### BACKGROUND

Currently, there are a large number of location-based services that allow users to “check-in” to a location. Examples include: Foursquare, Gowalla, Facebook Places, Yelp, etc. A user's mobile device may identify when a user is in a vicinity of a location, using for example a global positioning system (GPS), cellular tower triangulation, presence of identifying beacons, scanning a special visual tag of the location and/or WiFi access points, so that the user may check-in to that location. Location-based services use this check-in information to provide a variety of services and experiences to the user, including nearby friends' notifications, friends who have been here in the past, badges and rewards for simply checking-in, getting notified of nearby deals, etc.

There is currently no identified system for automated check-out from a location a user has checked into, once a user departs that location. This can lead to problems, such as for example friends erroneously believing the user is still at the location, a business offering a commercial incentive like a coupon even though the user has departed, as well as storing faulty data as to the user's activities and whereabouts.

### SUMMARY

Disclosed herein are systems and methods for detecting termination of a check-in session where a user has checked into a location using a mobile device. Upon detecting that the user has left a location, the present system automatically checks the user out of that location, updates the user's records, and notifies friends and any other interested and allowed principals that the user is no longer at that location.

In embodiments, the present system determines readings on one or more mobile devices such as mobile telephones at boundaries for a given location. This may be done a number of ways. The mobile devices may measure one or more of GPS data, mobile network radio signal strength, strength of a WiFi connection and/or other data and signals detected by a mobile device. By taking a reading or a number of readings at a variety of positions of a given location, signatures of the readings at the boundaries of the location may be established. These signatures, referred to herein as boundary signatures, may then be stored either on the device or on an off-device location like a web service and used for future reference to determine when a user has departed a location.

In particular, after a user has checked-in at a location, the user's mobile device continuously or periodically monitors data and signal information such as GPS data, mobile network radio signal strength, strength of a WiFi connection and/or other data and signals detected by a mobile device. This information is compared against the boundary signals to determine if and when the user departs the location and the mobile device is outside of the location boundaries. The mobile device may then automatically check-out from the location and provide an update of the departure to the user's records and friends.

In one example, the present technology relates to a method of detecting termination of a social check-in session where a user has checked into a location using a mobile device, the method comprising: (a) determining a boundary to the location; (b) monitoring at least one of data and signals of the mobile device; (c) detecting when the user has departed the location by the at least one of data and signals of the mobile device indicating that the mobile device is outside of the boundary of the location; (d) terminating the social check-in session upon detection of the mobile device being outside of the boundary of the location; and (e) notifying a friend of the user that the user has departed the location.

In another example, the present technology relates to a computer-readable storage medium for programming a processor to perform a method of detecting termination of a social check-in session where a user has checked into a location using a mobile device, the method comprising: (a) storing at least one of data and signals of one or more mobile devices positioned at a boundary of the location; (b) monitoring at least one of data and signals of the mobile device; (c) comparing the data and/or signals stored in said step (a) to the data and/or signals monitored in said step (b) to infer when a user has departed the location; and (d) terminating the social check-in session upon detection of the mobile device being outside of the boundary of the location.

In a further example, the present technology relates to a system for enabling social check-in to a location and check-out from the location, the system comprising: a mobile device running a software application, the software application capable of checking a user into the location, monitoring readings of the mobile device to infer when a user leaves the location, and automatically checking the user out of the location upon the inference that the user has left the location; and a centralized service in communication with the mobile device, the centralized service including a data storing having account records storing information of the user's check-ins and check-outs, the centralized service notifying friends of a user upon the user being checked out of a location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an example embodiment of the present system.

FIG. 2 is a block diagram of an example embodiment of a mobile device for use in the present system.

FIG. 3 is a flowchart of the operation of an embodiment of the present system.

FIG. 4 is a flowchart showing more detail of the check-out step of the present system.

FIG. 5 is a flowchart showing more detail of the step for defining boundary signatures according to the present system.

FIG. 6 is a flowchart showing more detail of the step for monitoring data and signal information of a mobile computing device and comparing that information to the boundary signatures.

FIG. 7 is a block diagram of a sample computing device on which embodiments of the present system may be implemented.

### DETAILED DESCRIPTION

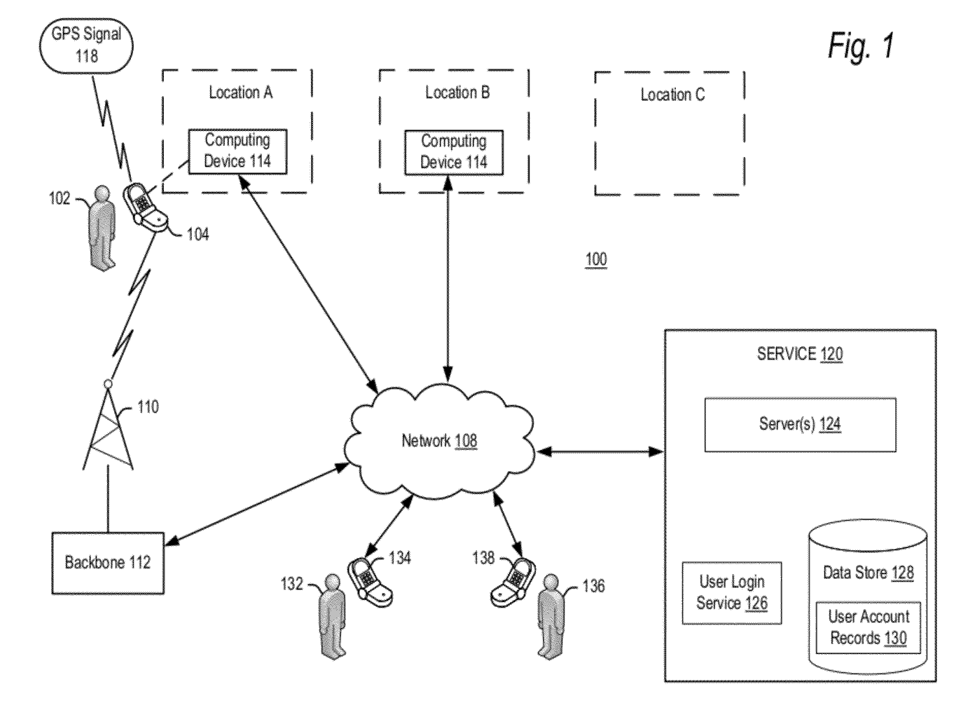

Embodiments of the present technology will now be described with reference to FIGS. 1-7, which in general relate to a method for automatically checking out of a location once the user departs the location. In general, a mobile device such as a cellular telephone receives a variety of signals and data indicative of the device's position. These signals and data include for example GPS data, WiFi access and network connection received signal strength indicator (RSSI), and cell tower RSSI. Additionally, when a user connects to a wireless network at a location, the user's mobile device may further receive a service set identifier (SSID) for that network and one or more basic service set identifiers (BSSID) for that network. A user may check into a location by a variety of methods, including receiving a prompt to check-in from the location or by the user performing some action, such as for example RFID or visual tag scanning.

After a user checks into a location, the present system may monitor one or more of the signals and data that the mobile device receives to determine when the user has left the location. If so, the system may check the user out of that location. Sensor data within the mobile device may also be used to infer the user's activity, which may also be factored into the determination as to whether a user has left a location. The system may additionally look for a check-in at a distinct new location to infer that the user has checked out of the prior location.

FIG. 1 illustrates a network topology 100 for implementing embodiments of the present system. The network topology 100 includes a user 102 having a mobile device 104. Mobile device 104 may be any of a variety of mobile computing devices, including for example a cellular telephone, a personal digital assistant (PDA) or other hand-held computing device, a computing tablet or a laptop computer. The mobile device 104 may have a connection to a network 108, which may for example be the Internet, through other networks including, but not limited to, a LAN or WAN are contemplated. Where the mobile device 104 is a cellular telephone, the mobile device may also have a connection to a base station 110 (one of which is shown) for forwarding data and software from mobile device 104 to a mobile network backbone 112. Backbone 112 may in turn have a network connection to network 108.

The topology 100 may further include brick and mortar locations where a user can check-in, such as for example Location A, Location B and Location C. There may be more or less than three such locations in further embodiments. Locations A and B have a computing device 114 supporting a wireless network. Location C does not. Each of the Locations A-C is shown bounded within a non-overlapping, rectangular area. It is understood that the rectangular shape is arbitrary and for the sake of illustration purposes only. As explained below, the present system may detect when a user departs from a given location. The location of the user when departing a given location may be outside or inside the arbitrary rectangular area shown for Locations A-C. Moreover, it is conceivable that a user may be presented with the option of checking into more than one of Locations A-C at a time.

As explained below, once a user checks-into a given location, that information may be transmitted to a service 120 via network 108. The information may be transmitted by the mobile device 104 and/or the computing device 114 at locations having a computing device 114. Service 120 may for example be an enterprise service provider, though it need not be in further embodiments. Service 120 may include one or more servers 124, which may for example include a web server, a game server supporting gaming applications, a media server for organizing and distributing selected media, or an ftp server supporting file transfer and/or other types of servers.

The service 120 also provides a collection of services, which applications running on mobile device 104 and/or computing devices 114 may invoke and utilize. For example, devices 104 and/or 114 may invoke user login service 126, which is used to authenticate a user seeking secure resources from service 120. The service 120 may further include a data store 128 including user account records 130. User account records may include a variety of data, including user profiles, user contacts, friends lists, location markers etc. User account records 130 may also store information relating to user check-ins at different locations, such as for example where and when a user is checked-in at a given location. While servers 124, login service 126 and data structure 128 are shown as part of a single service 120, some or all of these components may be distributed across different services in further embodiments.

FIG. 1 further shows users 132 and 136 having computing devices 134 and 138 respectively. The users 102, 132 and 136 may have their contacts and profiles set up in user account records 130 so that when user 102 checks into a location, this information is sent to service 120, which then forwards the location information of user 102 to users 132 and 136. There may be more or less additional users 132, 136, and computing devices 134, 138 may be mobile computing devices as in device 104, or they may be stationary computing devices such as a desktop computer or other device.

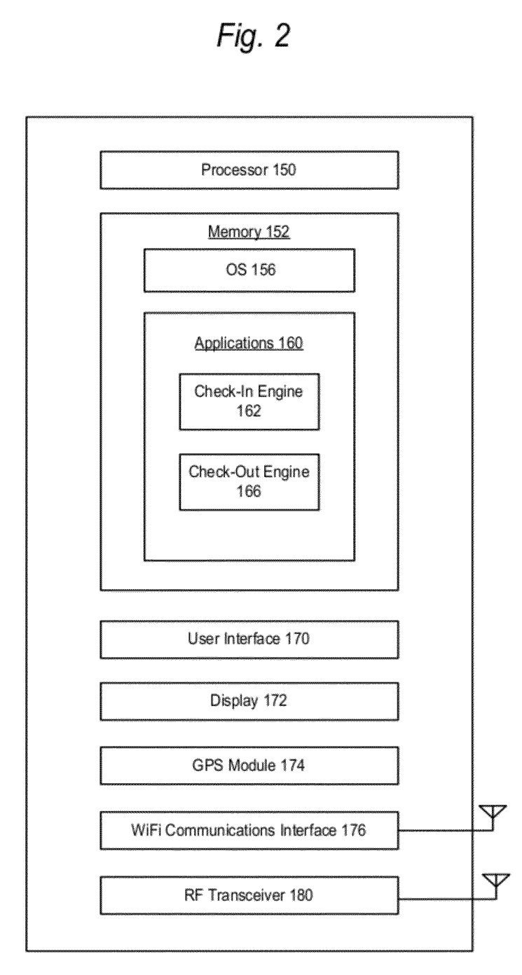

FIG. 2 is a block diagram of an example of mobile computing device 104. In embodiments, mobile device 104 may include a processor 150, which may be part of or include a digital baseband and/or an analog baseband for handling digital and analog signals. As is known, processor 150 may include a variety of electronics for handling incoming and outgoing digital voice and data signals.

Mobile device 104 may further include memory 152, for storing telephone numbers, contact information, etc. Memory 152 may additionally store photographic or video images taken with the mobile device 104. A variety of digital memory formats may be used for this purpose. In one embodiment, memory 152 may be a removable flash memory card, such as those manufactured by SanDisk Corporation of Sunnyvale, Calif. Memory 152 may further store an operating system 156 for the mobile device 104 and application programs 160.

One or more of these applications may be a social application allowing the user to check-in to a location and store data associated with the check-in (in memory 152 and/or within account records 130 in service 120). The data associated with the check-in may for example be where and when each check-in occurred, as well as badges and other awards associated by an application with a check-in. Such applications may include a check-in engine 162 for checking a user in at a location as explained below. Such application may further include a check-out engine 166 for checking a user out from a location as explained below. In embodiments, the check-in engine and check-out engine may be separate software modules, or they may be integrated into a single software module in further embodiments.

Mobile device 104 may further include a user interface 170 including a variety of hard and/or soft buttons, dials, switches, etc. for controlling features and operation of the computing device 114. The user interface 170 may operate over or in conjunction with a display 172.

The mobile device may further include a GPS module 174. Module 174 includes a receiver for receiving a GPS satellite signal 118 (FIG. 1) to allow the mobile device to determine its position as is known. The module 174 may further include a software application correlating GPS position data to known locations. Thus for example, where the GPS receiver identifies that the mobile device 104 is at a given position, the software module may indicate that the mobile device 104 is at Location A. The software module for correlating GPS position data to known locations may alternatively run on service 120, or elsewhere, and the identified location transmitted to the mobile device 104. In embodiments, GPS module 174 may be omitted from mobile device 104 so that mobile device 104 does not determine its absolute position.

Mobile device 104 may further include a WiFi communication interface 176 capable of wireless communication with a wireless network, such as may be supported by computing devices 114 within Locations A and B (FIG. 1). Communication interface 176 may operate according to various wireless protocols, including Bluetooth, RF, IR and/or RFID/Near Field Communication technologies to allow mobile device 104 to join any of a variety of wireless networks. Such wireless networks include for example a wireless personal area network, a wireless local area network and a wireless wide area network. Mobile device 104 may also include an RF transceiver 180 for modulating and transmitting voice and data signals from mobile device 104 to base station 110, and for receiving and demodulating voice and data signals from base station 110.

The various hardware and software components of mobile device 104 are described above by way of example only. It is understood that mobile device 104 may include additional hardware and/or software components. Moreover, as indicated above, mobile device 104 may be different types of devices. As such, different embodiments of a mobile device 104 may have different components tailored to the specific type of device in use.

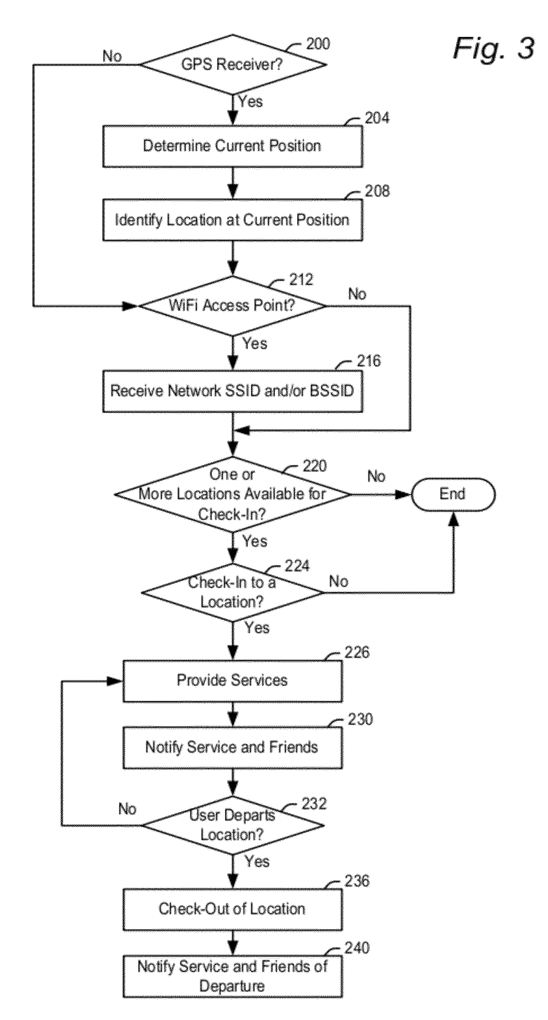

Operation of embodiments of the present system will now be explained with reference to the flowcharts of FIGS. 3-6. In general, the process involves initiating a check-in session at a location, such as one of Locations A, B and C, receiving services from the application supporting the check-in, detecting when the user departs the location, and checking the user out of the location upon detecting the departure. The location to which a user 102 may check-in may be any of various locations, such as brick and mortar businesses, landmarks, municipalities, transportation hubs, residences and a variety of other locations. As used herein, a location may also be a live event.

In step 200, the check-in engine 162 (FIG. 2) determines whether the mobile device includes a GPS receiver. If so, the check-in engine receives the current position of the mobile device 104 in step 204 and identifies whether there is a specific known location associated with that position in step 208. In further embodiments, a location-identification system such as GPS may continuously monitor mobile device position and relay that information to the check-in engine 162. The known location may for example be an address or the name of a brick and mortar location. As noted above, embodiments of the present technology may operate without GPS locator information.

In step 212, the check-in engine 162 next determines whether the mobile device is within range of one or more WiFi access points. If so, in step 216, the check-in engine receives the SSID for each such access point, and possibly one or more BSSIDs for each such access point.

In step 220, based on the information from steps 200-216, the check-in engine 162 determines whether there are one or more locations available for check-in. For example, in FIG. 1, the user may be at Location A. This information may be provided by the user's mobile device 104 providing GPS information and receiving an indication that Location A is at or near that location. Alternatively or additionally, the mobile device 104 may detect an SSID from an access point for a WiFi network from computing device 114 at Location A. If no check-in location is identified in step 220, there is nowhere to check into (and consequently nowhere to check-out of) and the routine may end.

On the other hand, if one or more locations are identified to which the user 102 may check into, the check-in engine 162 looks for such check-in in step 224. The user 102 may check into a location via the user interface 170 (FIG. 2) of mobile device 104. Alternatively, the mobile device 104 may interact with a scanner at the location, such as a RFID scanner or visual tag scanner at the location to check the user into the location. There may be only a single location or there may be multiple locations in the user's proximity to which the user 102 may check into. The user may be presented with all locations automatically to which the user may check into at any given time as the user moves around. Alternatively, locations available to the user for check-in may be presented to the user 102 only if and when the user 102 makes a request for such locations via the user interface 170 of the mobile device 104.

Once the user has checked into a location, the application running the check-in engine (or an application receiving information from the check-in engine) may provide different functionality and a variety of known services to the user 102 in step 226. For example, the check-in may result in rewards, including gaming rewards such as points, badges or honorary titles. The rewards may alternatively or additionally be special deals or discounts at the checked-in or other associated locations. Known applications for providing functionality and services upon check-in to a location are provided for example from Foursquare, Facebook, Gowalla, and Brightkite.

In step 230, the application operating in conjunction with the check-in engine 162 may upload information relating to the check-in to service 120, such as for example the time and location at which the user checks-in. This information may be stored in account records 130. Step 230 may further include notifying friends as to the user's current check-in location. The user 102 is free to set privacy policies and conditions with the service 120 as to when a friend is notified of the user's check-in.

It is understood that a user 102 may check into a location by any of a variety of other methods than that described above. One example showing additional and/or alternative steps in checking into a location is disclosed in U.S. Pat. No. 7,809,805, entitled “Systems and Methods for Automatically Locating Web-Based Social Network Members,” to Cheever et al. and assigned to Facebook, Inc., issued Nov. 2, 2010, which patent is incorporated by reference herein in its entirety.

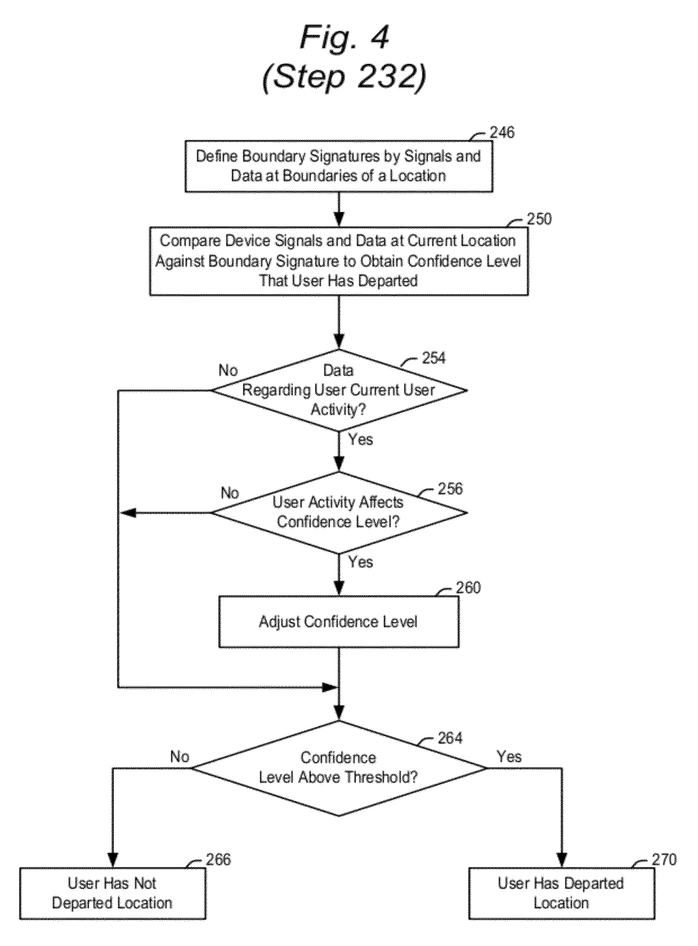

In accordance with the present system, in step 232, the check-out engine 166 determines whether a user departs or has departed from the location to which the user was checked-in. Further details of step 232 will now be described with reference to the flowchart of FIG. 4. In step 246, boundary signatures are defined for a given location based on test signals and data obtained by one or more mobile devices in the past. The boundary signatures in general represent readings, i.e. signals and data, captured by one or more mobile devices when at the boundaries of a given location. The boundary signatures may also include readings from within the location.

In embodiments, there may be different boundary signatures generated for different types of computing devices 114. For example, as explained below, one signal used in the boundary signature is signal strength of a mobile device at a boundary of the location. This is measured by the distance of mobile device 104 from the nearest base station 110. However, different mobile devices 104 may use different base stations 110. Accordingly, the boundary signature of a mobile device 104 having a first closest base station 110 may be different than the boundary signature of a mobile device 104 having a different closest base station 110. As explained below, the signals and data of a mobile device 104 are compared against the boundary signatures obtained in step 246 to infer whether the mobile device 104 is leaving a location. The boundary signatures used may be the specific boundary signatures for the same type of mobile device 104 being examined for departure from the location.

The boundaries defined by the boundary signatures may be precisely or nebulously defined boundaries. For example, as described below, GPS data may be used to define latitudinal and longitudinal boundaries of a location. In such a case, the boundaries of a location may be fairly precise, for example defined to within a few feet around a perimeter of a location. On the other hand, a boundary may be defined by signal strength of a user's mobile network. Where this is the only factor examined in a boundary signature, it may be that a user is a few blocks away from a location, or more, before the check-out engine is able to determine whether a user has departed from a location.

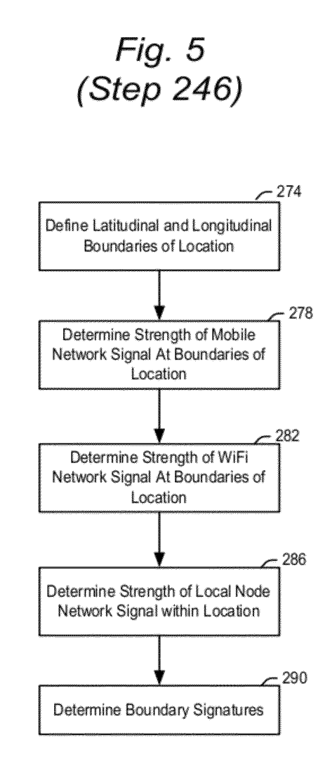

The flowchart of FIG. 5 shows further detail of the step 246 for defining a boundary signature for a mobile device 104. In step 274, GPS data may be used to define latitudinal and longitudinal data for the boundaries of a location. After the boundaries of a building have been defined with GPS data, this information may be used to determine whether a mobile device moves from within the boundary to outside of the boundary. Upon crossing over a boundary, the check-out engine 166 may determine that the user has left that location. It is noted that the boundaries of a location may be somewhat arbitrarily defined for this purpose. For example, where a location is a building, the walls of the building may be used as the boundary. Alternatively, some radius surrounding the walls of the building may be defined as the boundary.

In step 278, the RSSI of the radio signal of one or more mobile devices at the boundary of a location may be noted and stored for use in the boundary signatures. As noted above, the distance of a mobile device from a base station 110 may result in different signal strengths of the mobile device. By charting the signal strengths of one or more mobile devices at different positions at a location, this information may form part of the boundary signature. For example, a RSSI of the radio signal above some predefined level may be considered as being inside the boundary, while a RSSI of the radio signal below the predefined level may be defined as being outside of the boundary. As noted above, the one or more mobile devices used to form this aspect of the boundary signature should be consistent with each other, including for example all having their signal strength measured relative to the same base station 110.

As noted above, a location may have a computing device 114 and a WiFi network to which the computing device 114 may attach. In step 282, the SSID of a WiFi network and the RSSI of the network connection of one or more mobile devices at the boundary of a location may be noted and stored for use in the boundary signatures. For example, a RSSI of the network signal above some predefined level may be considered as being inside the boundary, while a RSSI of the network signal below the predefined level (or no signal at all) may be defined as being outside of the boundary. Moreover, a WiFi network within a location may include a number of localized hubs. In step 286, the BSSID of a local hub of a WiFi network and the RSSI of the local hub network connection of one or more mobile devices at the boundary of a location may also be noted and stored for use in the boundary signatures.

In step 290, the information from steps 274 to step 286 may be used to define boundary signatures for a given mobile device with respect to a particular location. This information is gathered and stored, for example within a computing device in a location, within a mobile computing device 104 and/or within service 120. The boundary signatures together may indicate a perimeter boundary for the location.

The data measured and stored for the boundary signatures in steps 274 through 286 may be obtained by a number of methods. In one example, crowd sourcing may be used where a number of different users measure the signals and data described above with mobile devices to get a variety of measurements of data and signals within and around a location. The boundary signatures may then be defined where GPS data is outside of a given perimeter, and/or where the RSSI of the radio signal and/or network connection signal falls below some predefined values. In further embodiments, wardriving may be used to measure WiFi access points around different positions of a location. In addition to data and signals taken at a boundary, data and signals at different locations within the location may also be determined and stored as part of the boundary signature. It is understood that data for defining boundary signatures may be obtained and stored in a variety of additional and/or alternative methods than those described above in FIG. 5.

Referring again to FIG. 4, after boundary signatures for a location have been obtained and stored in step 246, the data and signals from the mobile device 104 may be compared against the boundary signatures in step 250. In particular, after a user has checked into a location, the check-out engine may periodically or continuously take signal and data readings from the mobile device 104, and compare those against the signal and data readings forming the boundary signatures. The comparison is used to define a confidence level relating to the likelihood that the mobile device has departed the location.

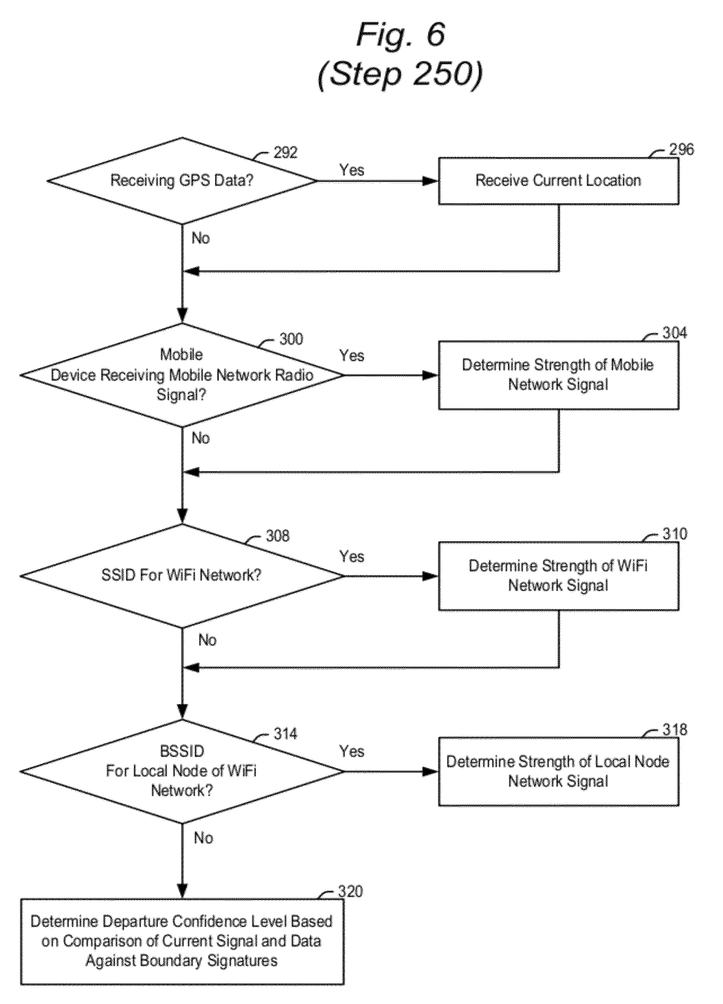

Further details of step 250 will now be explained with reference to the flowchart of FIG. 6. In step 292, the check-out engine 166 checks whether there is available GPS data. It may be that a mobile device does not receive GPS data, or that the GPS data is temporarily blocked. If so, GPS data for the mobile device 104 will not be used in the comparison against the boundary signature. If GPS data is available however, the current location of the mobile device 104 is received in step 296.

In step 300, the check-out engine 166 determines whether the mobile device is receiving a mobile network radio signal from a base station 110. If so, the RSSI of the received mobile network radio signal is measured in step 304. Similarly, in step 308, the check-out engine 166 determines whether the mobile device is receiving an SSID of a WiFi network within the location. If so, the RSSI of the received WiFi signal is measured in step 310. The same may be performed with respect to receiving a BSSID of a local node of a WiFi network in the location in steps 314 and 318.

In embodiments, in step 320, each measured signal and item of data is compared against the corresponding signals and data in the boundary signatures for that location. Where GPS data is available, that data is compared against the GPS data in the boundary signatures to determine whether the GPS data from the mobile device 104 indicates that the mobile device is inside of the location or has departed and is outside of the location. Where mobile network radio signal strength is available, that signal data is compared against the radio signal data in the boundary signatures to determine whether the radio signal strength in the mobile device 104 indicates that the mobile device is inside of the location or has departed and is outside of the location. The measured connection strength of the mobile device 104 to a WiFi network may be used in the same manner to determine whether the mobile device is inside of the location or has departed and is outside of the location.

The various signals and data generated by the mobile device 104 may be used in a variety of ways in the comparison to the boundary signatures to arrive at a confidence level. Each signal and data item described above may be weighted equally in reaching a confidence level. It may be clear in comparing the current GPS data of the mobile device 104 against the GPS data in the stored boundary signatures that the mobile device is outside of the location. If so, this factor would tend to increase the confidence level that the user has departed the location. It may also be clear in comparing the current RSSI for the mobile network radio signal against the same signal data in the stored boundary signals that the mobile device is outside of the location. If so, this factor would tend to increase the confidence level that the user has departed the location. The same may be so in comparing the current RSSI for the WiFi network connection. Based on the cumulative comparisons of the different factors, a confidence level may be determined.

Where signal and/or data information is missing from the current readings of the mobile device, that information is omitted from the comparison. For example, if only GPS information is available (the mobile device has no mobile network radio signal strength or a WiFi connection), then only portions of the boundary signature relating to GPS data are used in forming the confidence level.

Instead of weighting each of the above-factors evenly, one may be weighted more heavily than others. For example, it may be that GPS data is more accurate and reliable than signal strength of the radio signal or WiFi connection signal in determining whether the mobile device has departed a location. As such, in embodiments, the GPS data may be weighted more heavily than signal strength.

It is understood that the confidence level as indicated by the current readings of a mobile device may be determined upon comparison to stored mobile device readings by a variety of methods other than those described above. Moreover, the concept of arriving at a confidence level is described merely as one example. Further embodiments may operate without a confidence level. In such embodiments for example, when any of the GPS data, mobile network radio RSSI and/or WiFi network RSSI indicate that a mobile device is outside of a boundary when compared to the boundary signatures, this may be treated as the user having departed from the location.

Moreover, it is understood that other information from a mobile computing device may additionally or alternatively be used in determining whether a mobile device has left a given location. For example, referring again to FIG. 4, it may be that a mobile device is able to determine information relating to a current activity of user 102. As one example, GPS data or other motion sensors in a mobile device 104 may indicate that the user is moving at a rapid rate of speed. The speed may be that of a user running or the user driving in a car. Other examples are contemplated.

The check-out engine 166 may look for such indications of user activity in step 254. Where such user activity is detected, the check-out engine may determine in step 256 whether such user activity is predefined as being indicative of departure from a location (such as the above-identified example of a user driving in a car). If so, in embodiments using a confidence level, the confidence level may be adjusted upward accordingly in step 260. Some indicators of activity may indicate that a user is still in the location in step 256. Such indicators may adjust the confidence level downward in step 260.

Another indicator which may be used to determine that a user has left a first a location, such as Location A in FIG. 1, is whether the user has checked into another location, such as Location B. While check-in at a second location can indicate that the user has left the first location, this information does not indicate when the user left the first location. The locations may be distant from each other, and even where close to each other, there is no guarantee that the user went directly from the first location to the second location. As there is value in determining when the user left the first location, once the system detects check-in at a new location, the present system may employ various heuristics to look backward to determine when the user left the first location. For example, the system can look at GPS data or when there was a cellular base station 110 hand-off. A variety of other parameters known to the mobile device 104 may also be examined to determine when the user departed the first location in this scenario. Once the departure time from the first location is determined, that information may be stored in the user account records 130.

It may happen that there is a layered check-in scenario. For example, the user may check into a stadium or mall, and then check into a store or restaurant within the stadium or mall. In this instance, when the present system detects check-in at the nested location (store or restaurant in the above example), the system should not infer that the user has left the higher level location (stadium or mall in the above example). Thus, where the present system uses check-in at a second location to infer departure and checkout from a first location, the system may also check to make sure the first and second locations are distinct from each other. This information may be stored and used in the future by other mobile devices as indicative of a boundary of a location.

In step 264, the check-out engine 166 may determine whether the final confidence level is above some predefined threshold. If so, the check-out engine determines that the user has departed from the location in step 270. If the confidence level is below the threshold, the check-out engine determines that the user has not yet left the location in step 266. As noted above, alternative embodiments need not use the concept of a confidence level. One or more of the above-described factors (GPS, mobile network radio or WiFi signal strength, or user activity) may be determinative. Once one or more of these factors indicate that a mobile device is on the move or outside of the location boundary, the check-out engine 166 determines that the user has departed the location.

While embodiments of the present system use boundary signatures as a predefined characterization of the boundaries of a location, it is understood that the boundaries of a location may be defined by a variety of other methods in further embodiments. For example, the location of the mobile device may be known upon check-in. Moreover, the approximate size of the location may be known. The mobile device may include distance and motion sensing devices such as accelerometers so that the mobile device knows how far and in what direction the user has moved. Using this information together with a known size of the location, the present system may infer when a user has departed the location and then checkout as described below.

Referring again to FIG. 3, if it is determined in step 232 that a user has departed a location (as described with respect to FIGS. 4-6), the check-out engine 166 may check the user out of that location in step 236. The check-out engine 166 or other application making use of check-out engine 166 may then notify the service 120 that the user has departed, and the service 120 may then notify the user's friends 132, 136 (FIG. 1) that the user has departed. This notification may for example be by SMS text, email, instant messaging or any other mode of communication between mobile devices 104, 134 and 138. Additionally, a variety of user parameters may be stored in the service 120 based on the knowledge of the user's check-in and checkout. For example, the service 120 may store the length of time the user spent at the location, friends that were at the location, arrived at the location or departed the location while the user was at the location, incentives/rewards that were offered and accepted, what the user purchased at the location, etc.

In accordance with the present system, the account records 130 for a user 102 may accurately reflect the user's activities. The check-out engine allows the account records to note not only the user's arrival time at a location, but the user's departure time from that location and the length of time the user spent at the location. This may be used to provide valuable demographic information about the user. Moreover, noting that a user has departed from a location can prevent the wasted time of a user's friends looking for the user at a location that the user has already left.

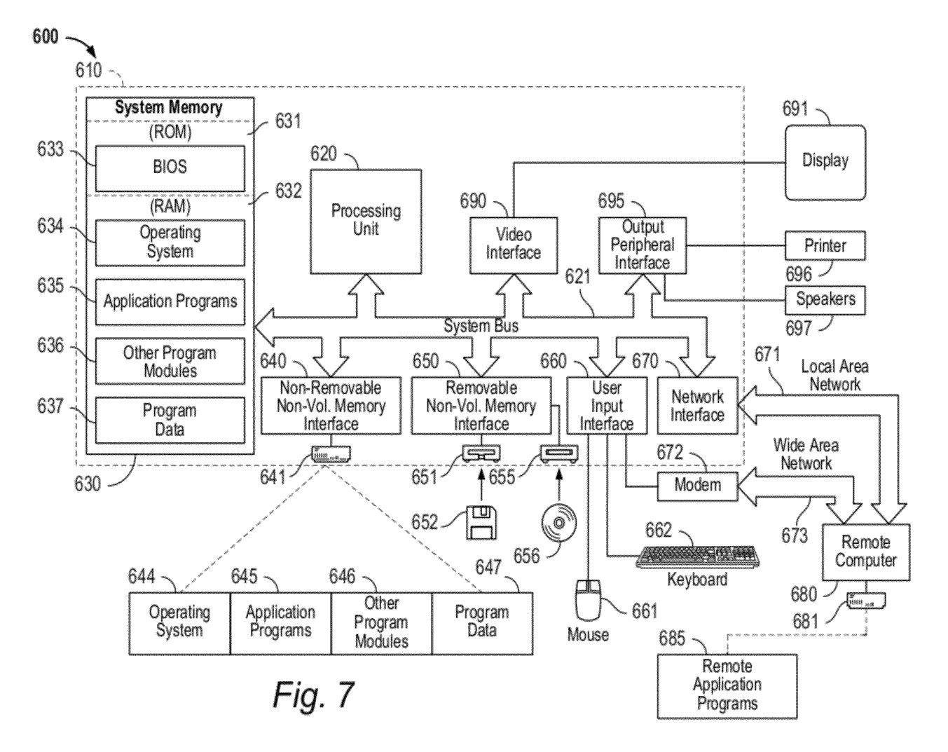

FIG. 7 shows an exemplary computing system which may be any of the computing systems mentioned above. FIG. 7 shows a computer 610 including, but not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 7 illustrates operating system 634, application programs 635, other program modules 636, and program data 637.

The computer 610 may also include other removable/non-removable, volatile/nonvolatile computer storage media. By way of example only, FIG. 7 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 7, provide storage of computer readable instructions, data structures, program modules and other data for the computer 610. In FIG. 7, for example, hard disk drive 641 is illustrated as storing operating system 644, application programs 645, other program modules 646, and program data 647. These components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 7. The logical connections depicted in FIG. 7 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 7 illustrates remote application programs 685 as residing on memory device 681. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

1. A method of detecting termination of a social check-in session where a user has checked into a location using a mobile device, the method comprising:
(a) determining a boundary to the location by capturing and storing at least one of signals and data using one or more mobile devices at a boundary of the location;
(b) monitoring at least one of data and signals of the user's mobile device;
(c) detecting when the user has departed the location by the at least one of data and signals of the user's mobile device indicating that the mobile device is outside of the boundary of the location;
(d) terminating the social check-in session upon detection of the user's mobile device being outside of the boundary of the location; and
(e) notifying a friend of the user that the user has departed the location.

2. (canceled)

3. The method of claim 1, wherein said step (b) of monitoring at least one of data and signals of the mobile device comprises the step of monitoring GPS data of the device.

4. The method of claim 1, wherein said step (b) of monitoring at least one of data and signals of the mobile device comprises the step of monitoring mobile network signal strength of the device and/or monitoring WiFi signal strength of a connection of the device to a WiFi network

5. The method of claim 1, wherein said step (b) of monitoring at least one of data and signals of the mobile device comprises the step of monitoring when a user checks into another location.

6. The method of claim 1, wherein said step (c) of detecting when the user has departed the location by the at least one of data and signals of the mobile device indicating that the mobile device is outside of the boundary of the location comprises the step of comparing the at least one of data and signals of the mobile device against the boundary determined in said step (a).

7. The method of claim 1, wherein said step (c) comprises the step of determining when the user has departed one of a brick and mortar business, a landmark, a municipality, a transportation hub, a residence or a live event.

8. A computer-readable storage medium not consisting of a modulated data signal, the computer-readable storage medium having computer-executable instructions for programming a processor to perform a method of detecting termination of a social check-in session where a user has checked into a location using a mobile device, the method comprising:
(a) storing at least one of data and signals of one or more mobile devices positioned at a boundary of the location;
(b) monitoring at least one of data and signals of the user's mobile device;
(c) comparing the data and/or signals stored in said step (a) to the data and/or signals monitored in said step (b) to infer when a user has departed the location; and
(d) terminating the social check-in session upon detection of the mobile device being outside of the boundary of the location.

9. The method of claim 8, wherein said step (c) comprises determining a confidence level that the user has departed the location based on the comparison of the data and/or signals stored in said step (a) to the data and/or signals monitored in said step (b).

10. The method of claim 9, wherein said step (c) further comprises inferring that the user has left the location when the confidence level exceeds a threshold level.

11. The method of claim 8, wherein said step (c) comprises inferring that the user has left the location when any of the data and/or signals monitored in said step (b) indicates that the user has left the location.

12. The method of claim 8, wherein said step (b) comprises continuously monitoring at least one of data and signals of the mobile device for comparison against the stored data and/or signals in said step (c).

13. The method of claim 8, wherein said step (b) comprises periodically monitoring at least one of data and signals of the mobile device for comparison against the stored data and/or signals in said step (c).

14. The method of claim 15, further comprising the step of notifying a service of the user's departure, the service including account records for the user.

15. The method of claim 8, further comprising the step of notifying friends of the user that the user has departed via the service.

16. A system for enabling social check-in to a location and check-out from the location, the system comprising:
a mobile device running a software application, the software application capable of checking a user into the location, monitoring readings of the mobile device to infer when a user leaves the location, and automatically checking the user out of the location upon the inference that the user has left the location; and
a centralized service in communication with the mobile device, the centralized service including a data storing having account records storing information of the user's check-ins and check-outs, the centralized service providing services to the user based on the location which the user is checked in to, the centralized service notifying friends of a user upon the user being checked out of a location.

17. The system of claim 16, the application on the mobile device monitoring GPS data of the device and comparing the monitored GPS data of the mobile device to stored GPS data relating to the boundary of the location to infer when the user is outside of the boundary indicated by the stored GPS data.

18. The system of claim 16, the application on the mobile device monitoring signal strength of at least one of a mobile network radio signal and a wireless network connection to a network of the location, and the application comparing the monitored signal strength of the mobile device to stored signal strength data of the mobile device at a boundary of the location to infer when the user is outside of the boundary indicated by the stored signal strength data.

19. The system of claim 16, the application on the mobile device monitoring data indicative of a user activity and inferring that a user has departed the location where the monitored data of user activity indicates that the user has departed the location.

20. The system of claim 19, the application on the mobile device monitoring data indicative of a user moving at a speed indicating that the user is no longer at the location.
